(19) United States
(12) Patent Application Publication
(10) Pub. No.: US 2026/0330348 A1
(43) Pub. Date: Oct. 22, 2026

(54) ARTIFICIAL INTELLIGENCE (AI) ENHANCED TEXT ASSISTANCE SYSTEM AND METHOD FOR SEPARATION OF DUTIES (SOD) BASED CONFLICT DETECTION AND RESOLUTION

(71) Applicant: Morgan Stanley Services Group Inc., New York, NY (US)

(72) Inventors: Nishi Kant, Bengaluru (IN); Ranveer Chaudhary, Bengaluru (IN)

(21) Appl. No.: 19/412,113

(22) Filed: Dec. 8, 2025

Related U.S. Application Data
(63) Continuation-in-part of application No. 19/183,118, filed on Apr. 18, 2025.

(51) Int. Cl. G06Q 10/0631; G06F 9/451; G06F 16/334

(52) U.S. Cl. CPC G06Q 10/063114; G06F 9/451; G06F 16/3344

(57) ABSTRACT

Systems and methods for implementing a Separation of Duties (SOD) based conflict detection and resolution are disclosed. An embodiment of the present invention is directed to a system architecture that incorporates an Artificial Intelligence (AI)-based SOD Text Assistant Chatbot directly within a SOD review interface to optimize and automate user interactions throughout the SOD review lifecycle. The AI-based SOD Text Assistant Chatbot may be integrated at the application layer, facilitating direct manipulation of application state and supporting automated population of form fields. Contextual awareness may be provided by dynamically extracting runtime context from the application, thereby enabling the SOD Text Assistant Chatbot to infer user actions and information needs.

### CROSS REFERENCE TO RELATED APPLICATIONS

This application is a continuation in part (CIP) application of U.S. patent application Ser. No. 19/183,118, titled “Separation of Duties Based Conflict Detection and Resolution,” filed Apr. 18, 2025, the contents of which are hereby incorporated by reference in its entirety.

### FIELD OF THE INVENTION

The present invention relates generally to implementing a separation of duties based conflict detection and resolution and more specifically to an AI-enhanced text assistance system and method that provides contextual guidance for improving the quality of free-text input fields in separation of duties review platforms.

### BACKGROUND

Separation of Duties (SOD) generally refers to the practice of dividing tasks among multiple users to prevent errors and fraud. SOD is based on the principle that no user should be given enough privileges to misuse the system on their own. For example, the person authorizing a paycheck should not also be the one who can prepare them. Separation of duties may be enforced by defining conflicting capabilities, e.g., capabilities which cannot be executed by the same user, as well as by enforcing the control at access time.

Existing solutions and platforms offer conflict calculations based on capabilities combinations for a user denoted by business processes. These products follow a manual process to map such entitlements to a conflict. These conflicts are highlighted when an entitlement request is placed on a request portal. In addition, the traditional method of having an audit process with SOD framework lacks sufficient detail as part of justification/commentary.

SOD Systems are widely implemented in enterprise environments to maintain security and compliance by preventing conflicts of interest and reducing the risk of fraud or errors. These systems typically identify potential conflicts when users are granted access rights or permissions that could create inappropriate combinations of duties within business processes. When conflicts are detected, organizations rely on review processes to evaluate whether the conflicts should be maintained with appropriate controls, revoked and/or handled through other risk mitigation strategies.

Current systems incorporate digital platforms that facilitate the review and documentation of conflict resolution decisions. These platforms typically include various interface elements such as dropdown menus, checkboxes, and structured data fields to capture reviewer decisions and supporting information. SOD review processes also incorporate free-text input fields where reviewers are expected to provide detailed justifications, explanations of risk mitigation controls or other narrative documentation to support their decisions.

While these free-text input fields allow for flexibility and detailed responses that cannot be captured through structured data elements alone, they often result in inconsistent, incomplete and/or inadequately detailed entries. Users oftentimes provide vague information, omit relevant details and/or include information that is consistent or otherwise insufficient. This variability in free-text input quality complicates subsequent audit processes and makes it difficult for compliance teams to efficiently assess the adequacy of risk mitigation measures.

The challenge of obtaining high-quality free-text input is particularly pronounced in compliance and audit contexts, where clear documentation of decision rationale is necessary for regulatory requirements and risk management. When free-text fields contain insufficient or unclear information, auditors and compliance personnel struggle to understand the basis for reviewer decisions, potentially leading to additional follow-up inquiries, delayed audit processes, and/or concerns about the adequacy of control documentation.

Accordingly, there is a need for an improved platform that provides for dynamic, context-aware assistance that adapts to the specific circumstances of each review case and provides intelligent feedback based on the relationship between structured selections and narrative explanations.

### SUMMARY

Systems and methods for implementing a policy-based detection engine that consumes different entitlement combinations to detect and resolve conflict anomalies are provided.

According to an embodiment, a separation of duties (SOD) based conflict detection and resolution system comprises: a computer server comprising one or more processors; an interactive user interface that receives one or more user inputs; and non-transitory memory comprising instructions that, when executed by the one or more processors, cause the one or more processors to: initiate, via the interactive user interface, a SOD exception interface executing on the SOD conflict detection and resolution system; activate, via the interactive user interface, a text assistant chatbot corresponding to the SOD exception interface; receive, via the text assistant chatbot, one or more queries associated with a user input type relating to the SOD exception interface; transmit, via the text assistant chatbot, the one or more queries to a data retrieval interface that is communicatively coupled to a retrieval augmented generation large language model and a vector database that provides real-time contextual information and further communicatively coupled to an artificial intelligence model that generates an AI-based response using the real-time contextual information; identify, via the interactive user interface, the user input type on the SOD exception interface as a selection-based input or a free-text input; responsive to the user input type, identify one or more prior selections and the real-time contextual information; provide, via the text assistant chatbot, text guidance based on the one or more prior selections, the real-time contextual information and the AI-based response; and synchronize one or more interactions via the text assistant chatbot with one or more inputs on the interactive user interface.

According to another embodiment, a computer-implemented method comprises the steps of: initiating, via an interactive user interface, a separation of duties (SOD) exception interface executing on a SOD conflict detection and resolution system; activating, via the interactive user interface, a text assistant chatbot corresponding to the SOD exception interface; receiving, via the text assistant chatbot, one or more queries associated with a user input type relating to the SOD exception interface; transmitting, via the text assistant chatbot, the one or more queries to a data retrieval interface that is communicatively coupled to a retrieval augmented generation large language model and a vector database that provides real-time contextual information and further communicatively coupled to an artificial intelligence model that generates an AI-based response using the real-time contextual information; identifying, via the interactive user interface, the user input type on the SOD exception interface as a selection-based input or a free-text input; responsive to the user input type, identifying one or more prior selections and the real-time contextual information; providing, via the text assistant chatbot, text guidance based on the one or more prior selections, the real-time contextual information and the AI-based response; and synchronizing one or more interactions via the text assistant chatbot with one or more inputs on the interactive user interface.

These and other advantages will be described more fully in the following detailed description.

### BRIEF DESCRIPTION OF THE DRAWINGS

In order to facilitate a fuller understanding of the invention, reference is made to the attached drawings. The drawings should not be construed as limiting the invention, but are intended only to illustrate different aspects and embodiments of the invention.

FIG. 1 is an exemplary illustration of separation of duties, according to an embodiment of the present invention.

FIG. 2 is an exemplary flowchart, according to an embodiment of the present invention.

FIG. 3 is an exemplary system diagram, according to an embodiment of the present invention.

FIG. 4 is an exemplary architecture system diagram, according to an embodiment of the present invention.

FIG. 5 is an exemplary review process, according to an embodiment of the present invention.

FIG. 6 is an exemplary conflict review process, according to an embodiment of the present invention.

FIG. 7 is an exemplary user interface, according to an embodiment of the present invention.

FIG. 8 is an exemplary flowchart, according to an embodiment of the present invention.

FIG. 9 is an exemplary flowchart, according to an embodiment of the present invention.

FIG. 10 is an illustration of privileged entitlements conflicts, according to an embodiment of the present invention.

FIG. 11 is an exemplary flowchart, according to an embodiment of the present invention.

FIG. 12 is an exemplary diagram, according to an embodiment of the present invention.

FIGS. 13A-D illustrate exemplary data structures, according to an embodiment of the present invention.

FIG. 14 is an exemplary system diagram, according to an embodiment of the present invention.

FIG. 15 is an exemplary flowchart, according to an embodiment of the present invention.

FIG. 16 is an exemplary flowchart, according to an embodiment of the present invention.

FIG. 17 is an exemplary interface, according to an embodiment of the present invention.

FIG. 18 is an exemplary interface, according to an embodiment of the present invention.

### DETAILED DESCRIPTION

Exemplary embodiments of the invention will be described in order to illustrate various features of the invention. The embodiments described herein are not intended to be limiting as to the scope of the invention, but rather are intended to provide examples of the components, use, and operation of the invention.

An embodiment of the present invention is directed to a Separation of Duties platform that implements a policy-based detection engine. The policy-based detection engine consumes various entitlement combinations of an entity's users and automatically runs policy-based rules on attributes to detect conflict anomalies.

The attributes may include: entitlement type; model; various indicators (e.g., “businessIndicator” “systemIndicator” “unstructuredDataIndicator” “privilegeAccessIndicator”, etc.); role type; identity; identifier type; grant date, revoke date; source type; fulfillment; reason for derived exclusion; expiration date, etc.

For example, a first rule may state that anyone with an ability to: manage payment limits cannot also have an ability to: facilitate cash management or complete check processing or approve payments and receipts. An embodiment of the present invention may analyze business processes for these rules and scan current entitlements to identify ones with relevant business processes. Then, the entitlements are grouped for a user. If a rule is fulfilled or otherwise triggered, a conflict may be identified and tagged against a user and rule combination.

Policy-based rules may run periodically, e.g., daily. Once a conflict is detected, a coverage-based review mechanism may be applied to determine whether to maintain or revoke the entitlement at issue. Other actions may be supported.

An embodiment of the present invention supports a variety of entitlements that may be collected and grouped together. Entitlements may include: direct, inherited, persistent, temporary, business, technology, etc. Entitlements may be within a role group and also include internal or external entitlements. An embodiment of the present invention may support Conflict As A Service for various entitlement generating and provisioning systems and services.

An embodiment of the present invention is directed to a policy-based capture of separation of duties violations elements. This may include an entitlement model and an organizational hierarchy process. An embodiment of the present invention may include a complex entitlement model for various diverging entitlement combinations; a policy-based conflict detection engine and a review process to resolve conflicts. In addition, the results of the review process may be used to further refine the overall analysis.

An embodiment of the present invention is directed to a Separation of Duties (SOD) program that may be part of a firmwide framework to identify and manage potential conflicts arising from toxic combinations of system access to reduce an entity's risk footprint. This may cover potential areas for Business (e.g., prevents system users from holding conflicting business entitlements), Technology (e.g., prevents technologists from holding conflicting entitlements across environments) and BizTech (e.g., prevents technologists from holding technology entitlements that enable them to mimic a business entitlement).

An embodiment of the present invention is directed to simplifying an entitlement model structure so that a policy may run rules. This solves challenges related to entitlement coverage and internal risk. Separation of Duties resolution is imperative to mitigate internal risk arising from toxic combinations.

An embodiment of the present invention identifies capabilities that are in conflict and is not limited to entitlements, but considers the capability of a user (e.g., what he/she can do and what he/she should not). The capabilities may then be traced back to the entitlements. By focusing on the user capability, an embodiment of the present invention identifies direct correlations to the entitlement covered through Technology SOD and Business SOD. The innovative system may further identify indirect access attained through inheritance, such as privileged access to a system leading to BizTech SOD. Considering the user's capabilities enables an embodiment of the present invention to identify and more accurately address entitlements (e.g., indirect, inheritance, etc.) that normally would be undetected or overlooked.

An embodiment of the present invention is directed to an ability to determine what is assigned to a user including individual functionalities and then mapping that information to potential conflicts. The conflict may be based on the user activity (as opposed to assignments).

An embodiment of the present invention recognizes that an assignment of a group level does not necessarily uncover conflicts that may occur through multiple layers of indirection. By tracing an entire tree of indirection, an embodiment of the present invention is able to accurately identify what a user is allowed to do and find conflicts that would have been missed otherwise.

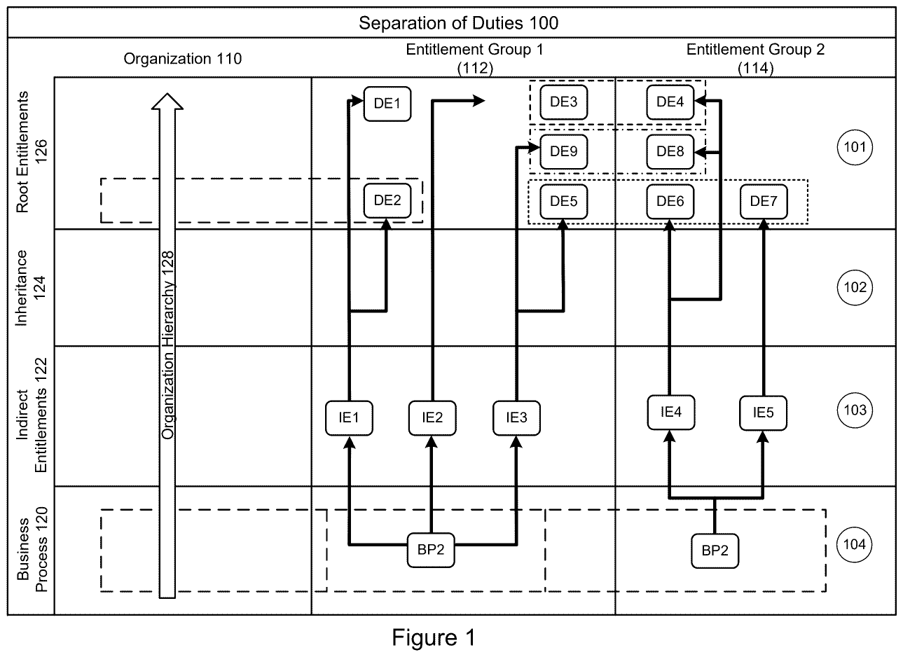

FIG. 1 is an exemplary illustration of separation of duties, according to an embodiment of the present invention. As shown by stage 101 in FIG. 1, a toxic combination of “Direct/Root entitlements” may create a conflict.

At an Organization 110, Separation of Duties 100 may be shown between Entitlement Group 1 (112) and Entitlement Group 2 (114). Separation of Duties 100 may extend from Business Process 120, Indirect Entitlements 122, Inheritance 124 to Root Entitlements 126, as shown by Organization Hierarchy 128.

Section 101 illustrates Direct Entitlements (DE). Direct Entitlements Conflicts represent conflicts arising from a combination of entitlements assigned to a user. For example, a combination of DE3 and DE4 may represent a conflict. Other combinations at issue may include DE9 and DE8 as well as DE5, DE6 and DE7.

Section 102 illustrates Inheritance Entitlements. Inheritance Entitlements may represent an entitlement lineage where one indirect entitlement governs underlying entitlements (e.g., development role (indirect entitlement) may have read and write entitlements on an asset in a DEV environment).

Section 103 illustrates Indirect Entitlements (IE). Indirect Entitlements may represent group entitlements, e.g. Developer, Administrator, Production support, etc.

Section 104 illustrates Business Process Conflicts that demonstrate conflicts arising from a combination of functionality that a user may do or combining the functionality the user may perform within an organization. According to an embodiment of the present invention, Business Processes may include capabilities that an entity may perform. For example, a process lineage may be represented by: Process Taxonomy>Finance Services>Treasury Services>Consolidate and Assess Capital Projections. Business Processes such as trade booking and trade settlement should not coexist for a user. This combination may be marked as a toxic combination of business processes. An embodiment of the present invention is directed to analyzing business processes, extracting underlying entitlements and applying business oriented rules.

Current solutions do not analyze or address SOD conflicts at the business process level and therefore fail to accurately address inherent, inheritance and other relevant entitlements.

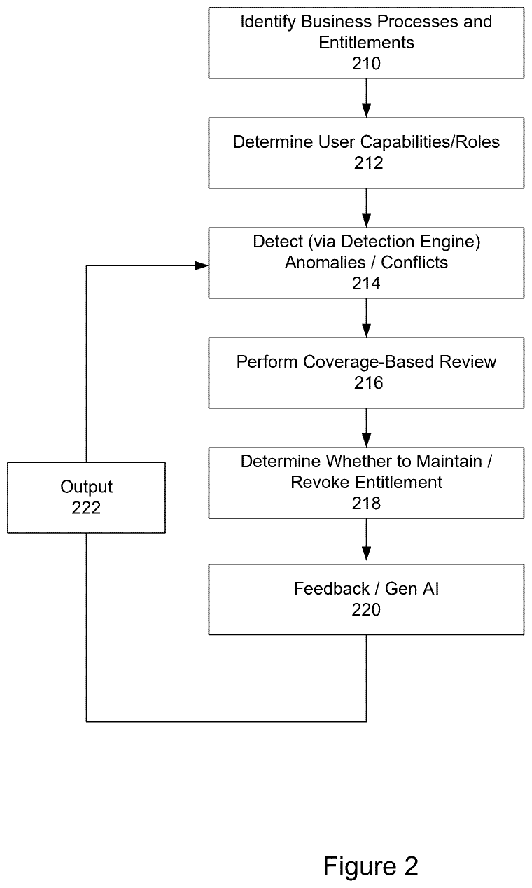

FIG. 2 is an exemplary flowchart, according to an embodiment of the present invention. At step 210, one or more business processes and associated entitlements may be identified. The business process may relate to an application implemented by an entity. For each business process, a set of entitlements may be determined. The entitlements may include: indirect entitlements, inheritance entitlements and root entitlements. At step 212, a set of capabilities or roles associated with a specific user may be determined. For example, the entitlements may be grouped for a specific user. At step 214, a detection engine may detect anomalies or conflicts based on business processes. A set of policy-based rules may be applied to detect one or more separation of duties (SOD) conflicts for the specific user and the set of entitlements. At step 216, a coverage-based review may be performed. This may include a multi-step review process. At step 218, a decision whether to maintain or revoke an entitlement may be performed.

At step 220, the output of the decision may be used to improve anomaly/conflict detection. As shown by 222, the output may be applied to step 214. For example, Generative AI (“GenAI”) may be applied in the evaluation of policies against rules and ensuring that business policies have been appropriately applied. In addition, GenAI may be used to extract detailed information relating to entitlements by evaluating descriptions provided by users in support of maintaining entitlements. This may arise when users provide detailed descriptions and/or risk justifications in support of using entitlements and how access is being used. This information may be further used to generate insights and further align the system to how users interact and use the system.

While the process of FIG. 2 illustrates certain steps performed in a particular order, it should be understood that the embodiments of the present invention may be practiced by adding one or more steps to the processes, omitting steps within the processes and/or altering the order in which one or more steps are performed.

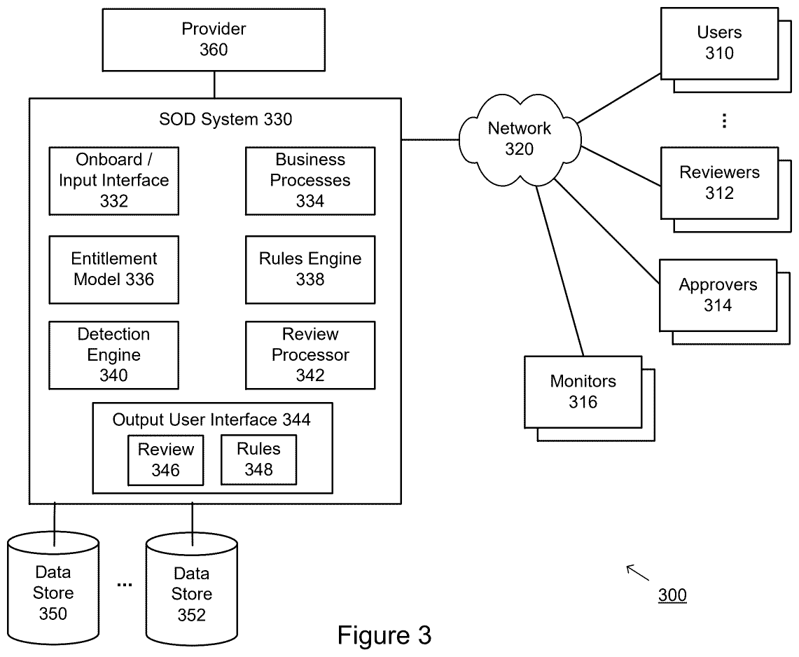

FIG. 3 is an exemplary system diagram, according to an embodiment of the present invention. FIG. 3 illustrates a schematic diagram of a system that implements Separation of Duties Based Conflict Detection and Resolution, according to an exemplary embodiment. As illustrated in FIG. 3, Network 320 may be communicatively coupled to SOD System 330 via various computing devices. Computing devices may include computers, laptops, workstations, kiosks, terminals, tablets, mobile devices, mobile phones, smart devices, etc. Various users may interact with SOD System 330 through Network 320. Users 310 may include Reviewers 312, Approvers 314 and Monitors 316.

Network 320 communicates with SOD System 330 that provides SOD based conflict detection and resolution. SOD System 330 may include Onboard/Input Interface 332, Business Processes 334, Entitlement Model 336, Rules Engine 338, Detection Engine 340, Review Processor 342 and Output User Interface 344.

Onboard/Input Interface 332 may interface with various systems to receive requests and entitlement data. An onboarding process may receive/ingest entitlements and associated metadata. This enables Onboard/Input Interface 332 to analyze hundreds and hundreds of entitlements by metadata. For example, an entitlement metadata may indicate a relation to payments entitlements. Accordingly, an embodiment of the present invention provides a metadata based input approach as opposed to relying on direct linkages to specific entitlements.

Business Processes 334 may analyze and manage various business processes related to an entity, application, industry, etc. Business Processes 334 may include trading, payments, settlements, etc. In this example, a business process based rule may indicate that the same person should not have an ability to execute trades and also approve payments.

In addition, when a system, application, service, etc. is onboarded, an embodiment of the present invention may identify relevant business processes for certain functions. For example, when a payment system is implemented, an embodiment of the present invention may recognize that the payment system is in scope for SOD controls for payment activities. The relevant business processes may be analyzed to identify SOD conflicts, according to an embodiment of the present invention.

Entitlement Model 336 may generate and refine a model that extracts entitlements from various business processes. While an Entitlement Model 336 is illustrated, other types of access and/or control may be considered.

Rules Engine 338 may include a processor that analyzes entitlement rules based on business processes.

Detection Engine 340 may include a processor that detects potential anomalies, conflicts, etc. Detection Engine 340 may be modelled to evaluate what an application can do, what an entitlement in an application gives user access to along with any indirect access to the system provided by the entitlements. It may be dependent on the taxonomy of functional processes which may be defined as a “Business Process.” These taxonomies may be utilized to assist with a scoping criteria for the detection logic as it helps classify the functions performed by various resources, including people and technology assets. The conflict may be calculated real time and mitigated during an approval process which may be a proactive control.

Review Processor 342 may apply a multi-step review process for entitlements and interact with various users including Reviewer, Approvers and Monitors.

Output User Interface 344 may include an interactive interface for analyzing, maintaining, and/or rejecting requests via Review 346. In addition, rules may be applied, defined, generated, modified, processed, etc. via Rules 348. Others users and integrations may be supported.

The system components are exemplary and illustrative, SOD System 330 may interact with additional modules, a combination of the modules described and/or less modules than illustrated. While a single illustrative block, module or component is shown, these illustrative blocks, modules or components may be multiplied for various applications or different application environments. In addition, the modules or components may be further combined into a consolidated unit. The modules and/or components may be further duplicated, combined and/or separated across multiple systems at local and/or remote locations. Other architectures may be realized.

SOD System 330 may be communicatively coupled to data storage devices represented by Data stores 350, 352. Data stores 350, 352 may also store and maintain entitlement data, business processes, taxonomies, source code, reports, performance data, historical data, etc. The conflict detection and resolution features described herein may be provided by SOD System 330 and/or a third party provider, represented by 360, where Provider 360 may operate with SOD System 330.

The system 300 of FIG. 3 may be implemented in a variety of ways. Architecture within system 300 may be implemented as hardware components (e.g., module) within one or more network elements. It should also be appreciated that architecture within system 300 may be implemented in computer executable software (e.g., on a tangible, non-transitory computer-readable medium) located within one or more network elements. Module functionality of architecture within system 300 may be located on a single device or distributed across a plurality of devices including one or more centralized servers and one or more mobile units or end user devices. The architecture depicted in system 300 is meant to be exemplary and non-limiting. For example, while connections and relationships between the elements of system 300 is depicted, it should be appreciated that other connections and relationships are possible. The system 300 described below may be used to implement the various methods herein, by way of example. Various elements of the system 300 may be referenced in explaining the exemplary methods described herein.

Network 320 may be a wireless network, a wired network or any combination of wireless network and wired network. Network 320 may further include one, or any number of the exemplary types of networks operating as a stand-alone network or in cooperation with each other. Network 320 may utilize one or more protocols of one or more network elements to which it is communicatively coupled. Network 320 may translate to or from other protocols to one or more protocols of network devices. Although Network 320 may be depicted as one network for simplicity, it should be appreciated that according to one or more embodiments, Network 320 may comprise a plurality of interconnected networks, such as, for example, a service provider network, the Internet, a cellular network, corporate networks, or even home networks, or any of the types of networks mentioned above.

Data may be transmitted and received via Network 320 utilizing a standard networking protocol or a standard telecommunications protocol. For example, data may be transmitted using protocols and systems suitable for transmitting and receiving data. Data may be transmitted and received wirelessly or in some cases may utilize cabled network or telecom connections or other wired network connection.

While FIG. 3 illustrates individual devices or components, it should be appreciated that there may be several of such devices to carry out the various exemplary embodiments. SOD System 330 may communicate using any mobile or computing device, such as a laptop computer, a personal digital assistant, a smartphone, a smartwatch, smart glasses, other wearables or other computing devices capable of sending or receiving network signals. Computing devices may have an application installed that is associated with Provider 360.

SOD System 330 may be communicatively coupled to Data Stores 350, 352 as well as remote storages. These storage components may include any suitable data structure to maintain the information and allow access and retrieval of the information. The storage may be local, remote, or a combination. The storage components may have back-up capability built-in. Communications with the storage components may be over a network, such as Network 320 or communications may involve a direct connection between the various storage components and Provider 360, as depicted in FIG. 3. The storage components may also represent cloud or other network based storage.

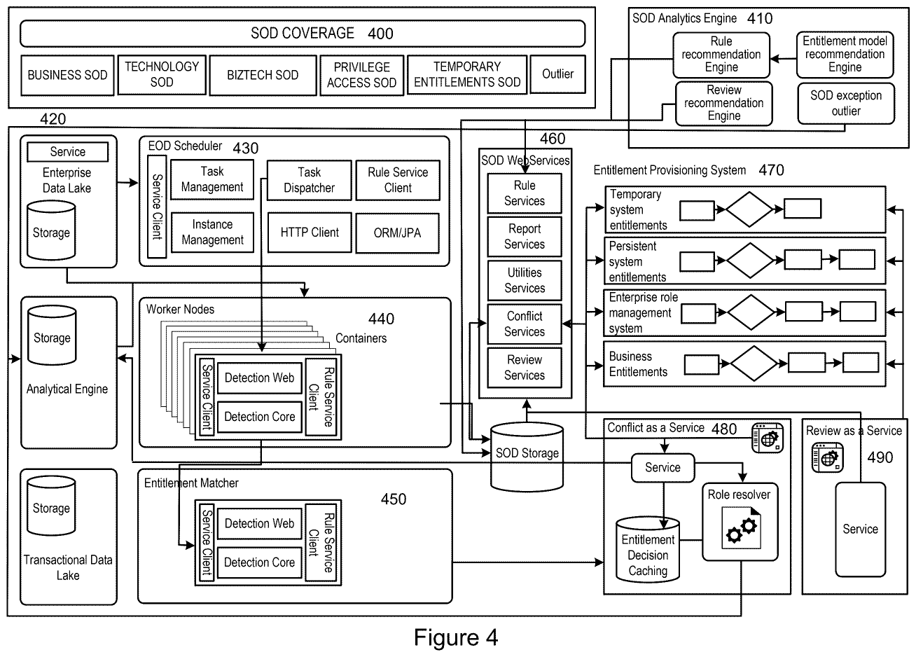

FIG. 4 is an exemplary architecture system diagram, according to an embodiment of the present invention. As shown by FIG. 4, SOD Coverage 400 may include Business SOD, Technology SOD, BizTech SOD, Privilege Access SOD, Temporary Entitlements SOD and Outlier. FIG. 4 illustrates a scalable system that may be applied to various use cases, applications scenarios, etc.

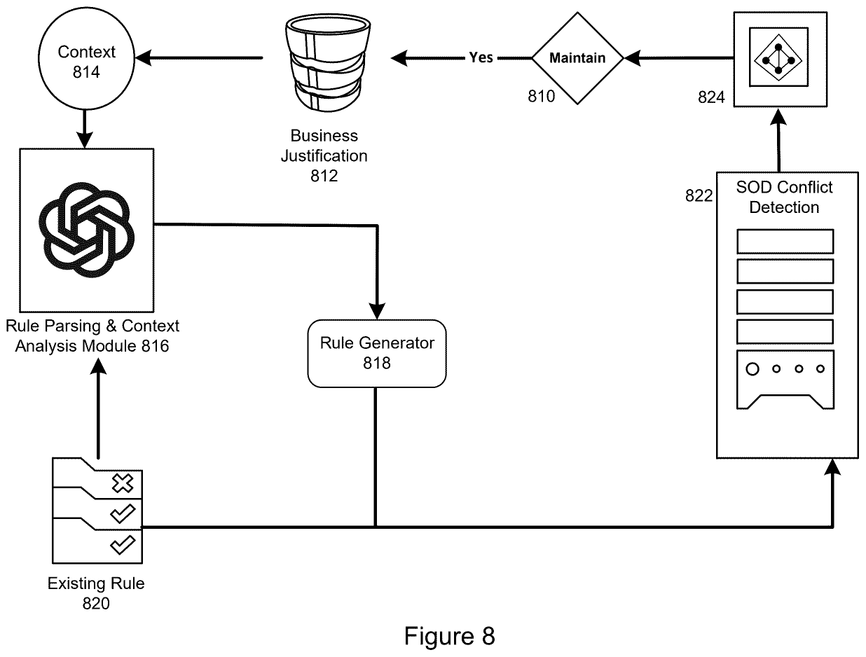

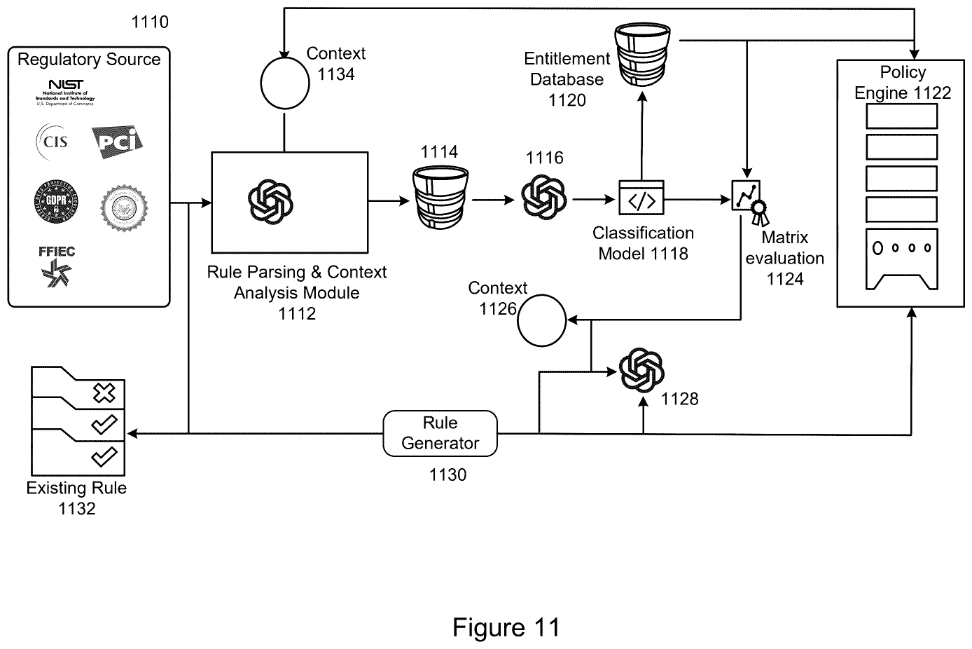

SOD Analytics Engine 410 may include: Rule Recommendation Engine, Entitlement Model Recommendation Engine, Review Recommendation Engine and SOD Exception Outlier. Rule Recommendation Engine and Entitlement Model Recommendation Engine are detailed in FIGS. 8 and 11 below. Review Recommendation Engine may represent an AI/ML based model that uses a classification model to recommend review decisions based on historical trend, user profile, etc. SOD Exception Outlier may represent an analytical process that analyzes data not considered for SOD/exception and evaluates whether the SOD Analytics Engine 410 has missed any patterns.

Services 420 may include EOD Scheduler 430, Worker Nodes 440 and Entitlement Matcher 450. EOD Scheduler 430 may include Service Client, Task Management, Instance Management, Task Dispatcher, HTTP Client, Rule Service Client, and ORM/JPA. Worker Nodes 440 may include a plurality of containers with Service Client, Detection Web, Detection Core and Rule Service Client. Entitlement Matcher 450 may include Service Client, Detection Web, Detection Core and Rule Service Client. Storage components may include Enterprise Data Lake, Analytical Engine, Transactional Data Lake. Task Dispatcher, as shown in section 430, and Worker Nodes 440 may represent a master slave architecture. Worker Nodes 440 represent containers executing in parallel. Task Dispatcher may create a task and dispatch it to a worker node. The worker node may work to complete the task. In this example, a master node keeps track of task status and once completed, it may assign a new task as part of horizontal scaling. Entitlement Matcher 450 may support avoiding recalculation until needed. For example, a rule in SOD may be two-sided. While EOD Scheduler 430 executes batch detection, an embodiment of the present invention continues to match entitlements to the rule which may be reused if a user requests new entitlements with any of these existing entitlements and thereby avoids recalculation.

SOD Web Services 460 may include: Rule Services, Report Services, Utilities Services, Conflict Services and Review Services. Entitlement Provisioning System 470 may include: Temporary System Entitlements, Persistent System Entitlements, Enterprise Role Management System and Business Entitlements.

Other Services may include: Conflict as a Service 480 and Review as a Service 490. Conflict as a Service 480 may include Service, Role Resolver and Entitlement Decision Caching. These Services may be called through an API or other interface.

An embodiment of the present invention provides a level of granularity and specificity of entitlements that may be leveraged to make intelligent decisions on whether a set of entitlements is a toxic combination and generate a conflict. An embodiment of the present invention is directed to a process that relies not just on the entitlement that is granted to the user but also on what the user can do using the same.

An embodiment of the present invention is directed to a proactive SOD risk management. SOD (Conflict As A Service) 480 provides a conflict service to various entity provision systems. When an entitlement is requested, SOD conflict may be calculated/determined in response. When a conflict is determined, a review process may be initiated at 490. Upon granting a SOD review process, the entitlement may then be approved. Accordingly, this process reduces risk of toxic entitlement combinations.

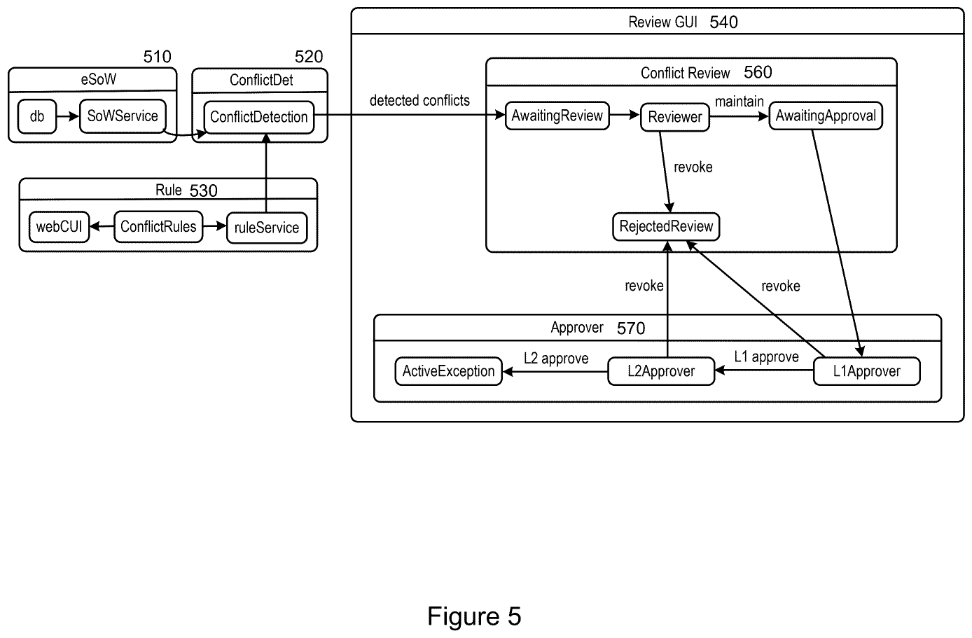

FIG. 5 is an exemplary review process, according to an embodiment of the present invention. FIG. 5 illustrates a conflict detection and conflict review overall process.

As shown in FIG. 5, eSOW 510 may access database (db) and send a SOW Service request to Conflict Detection 520. Conflict Detection 520 may access conflict rules through a web interface and/or rule service, as shown by Rule 530. Detected conflicts may be sent to Conflict Review 560. Through a review interface 540, a reviewer may access a detected conflict and then determine whether to maintain through awaiting approval or revoke through rejected review. Additional Approvers (L1 Approver and L2 Approver) may review and determine whether to revoke or process as an exception at 570.

An embodiment of the present invention is directed to a multi-step coverage-based review process that enhances accuracy and control. An embodiment of the present invention may support various types of users, including Reviewers, SOD Approvers (of varying levels), Monitors, etc.

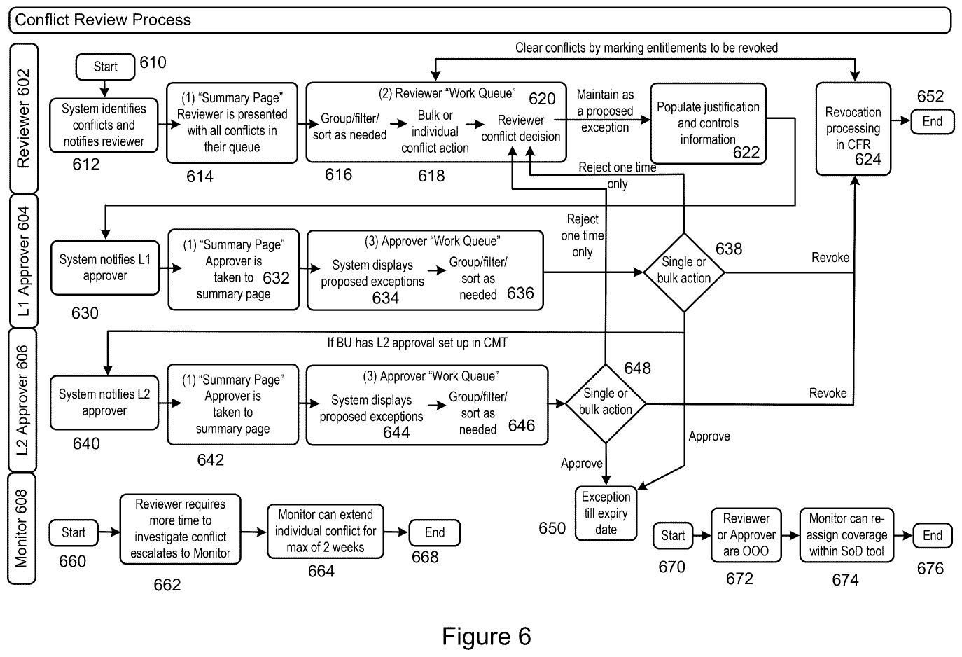

FIG. 6 is an exemplary conflict review process, according to an embodiment of the present invention. Various users including Reviewer 602, L1 Approver 604, L2 Approver 606 and Monitor 608 may interact with a conflict review process.

Reviewer 602 may be responsible for remediating/maintaining a conflict. If a conflict is maintained, a second level of approval may be required.

For all maintains, an approval may be required. The Approver (e.g., SOD Level 1 Approver) 604 may review the maintained conflicts and rationale provided by a Reviewer.

A second level of approval may be available to business units. This additional Approver (e.g., SOD Level 2 Approver) 606 may be given additional time to approve, e.g., 5 days.

Monitors 608 may need to follow-up with Reviewers and Approvers for pending violations. Monitors 608 may also be responsible for filling coverage gaps to ensure timely review completion for their area. Other types of reviewers with varying levels of responsibilities may be supported.

A conflict review process may start at 610 where a system identifies a conflict and notifies a reviewer at 612. Through an interface (e.g., summary page), the reviewer may be presented with conflicts in a queue at 614. Through a work queue interface, the reviewer may process the conflicts through group, filter, sort as needed at 616. Bulk or individual conflict action may be determined at 618. A conflict decision may be determined at 620.

Conflicts may be cleared by marking entitlements to be revoked at Revocation Processing in CFR (Revocation Engine) 624. CFR 624 may represent a centralized entitlement revocation platform that views and updates revocations generated by an entitlement revocation process. Entitlements may be maintained as a proposed exception and population justification and controls information at 622. According to an exemplary illustration, the entitlement may be rejected one time only. Other conditions may be applied.

The system may notify L1 approver at 630. The approver may be presented with an interface (e.g., summary page) at 632. Through a work queue interface, the approver may view proposed exceptions at 634 and group, filter, sort as needed, at 636. Actions may be determined as single or bulk actions at 638. The exception may be revoked at Revocation Processing in CFR, at 624. If a business unit has L2 Approval set up, the system may notify L2 approver, at 640.

The approver may be presented with an interface (e.g., summary page) at 642. Through a work queue interface, the approver may view proposed exceptions at 644 and group, filter, sort as needed at 646. Actions may be determined as single or bulk actions at 648. The exception may be revoked at Revocation Processing in CFR at 624. The exception may be approved until an expiry date or other condition. The process may end at 652.

For Monitor, a process may start at 660 where a Reviewer may require more time to investigate a conflict which may then be escalated to Monitor at 662. Monitor may extend an individual conflict for a period of time at 664. The process may end at 668. Another process may start at 670 where a reviewer or approver is out of office at 672. Monitor may reassign coverage within SOD tool at 674 and the process ends at 676.

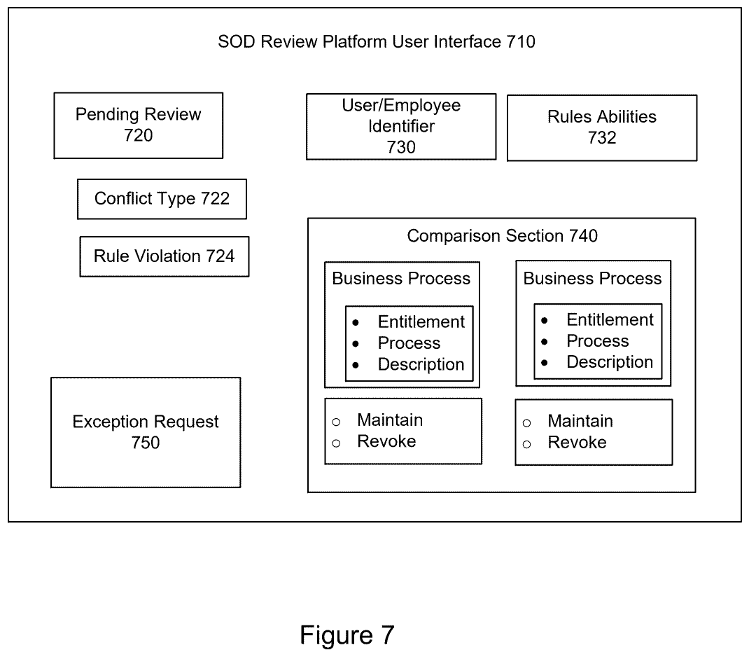

FIG. 7 is an exemplary user interface, according to an embodiment of the present invention. SOD review portal may resolve SOD rules based on business processes and further highlight combinations of entitlements that are creating conflicts. It allows an opportunity to a reviewer to evaluate and determine whether entitlements should be revoked in order to remove conflicts or whether there is a genuine use case to maintain entitlements for a limited duration or other condition.

As shown FIG. 7, a user interface (as shown by SOD Review Platform User Interface 710) may include various interactive sections including: Pending Review 720 and Comparison Section 740. Pending Review 720 may enable filtering by conflict type 722 (e.g., Biztech SOD, Business SOD, Technology SOD, Outliers, etc.) as well as other metrics/characteristics. Pending Review 720 may identify a user and associated violations of specific rules (e.g., user identifier, rule identifier, etc.) at 724. Additional information regarding the user may be provided at 730 and what the user is able to do at Rule Abilities 732. This may include user identifier, division, cost center, enterprise role, associated rules and abilities.

The Comparison Section 740 may compare a first set of business processes and a second set of business processes. Business Processes may include: identifier, (parent) entitlement name, business process (e.g., calculate daily risk, execute trade), entitlement description (e.g., ability to run risk, sales users can book, amend and cancel trades), etc. Comparison Section 740 may enable the user to maintain or revoke business processes.

If the reviewer decides to maintain the entitlement, proper control details may be added. For example, a limited set of control and justification categories may be allowed to maintain entitlement for a maximum allowed time limit. Other conditions may be provided.

A Rule Exception Request Interface, as shown by Exception Request 750, may enable a user to identify Control Type; Control Category Comment; Justification Category, Business Justification, Expiration Date and Comments. An exception management feature of an embodiment of the present invention enables a reviewer to propose an exception and further manage those exceptions.

FIG. 8 is an exemplary flowchart, according to an embodiment of the present invention. An embodiment of the present invention is directed to an AI-based rule recommendation using a review decision feedback loop.

As part of regular review cycle when conflicting entitlements are maintained at 810 along with control type and justification category, business justification 812 may also be provided. AI/ML model through Rule Parsing and Content Analysis Module 816 may be applied to comments (or other context shown by 814) as a commentary feedback loop and generate rule modification at 818. The comments and/or feedback loop may then be evaluated and vetted against current rule engine (as shown by Existing Rule 820) to validate through SOD Conflict Detection 822 and SOD Review Process 824. As shown in FIG. 8, each SOD conflict may have an associated review process where the decision may include: maintain or revoke. When the decision includes maintaining an entitlement for a conflict, a business team may be asked to provide additional justification. This may involve identifying a different justification category. The AI/ML or GenAI model may analyze the justifications along with rules and entitlement model and then generate a modified/new rule or recommend entitlement reclassification. Other actions/responses may be generated.

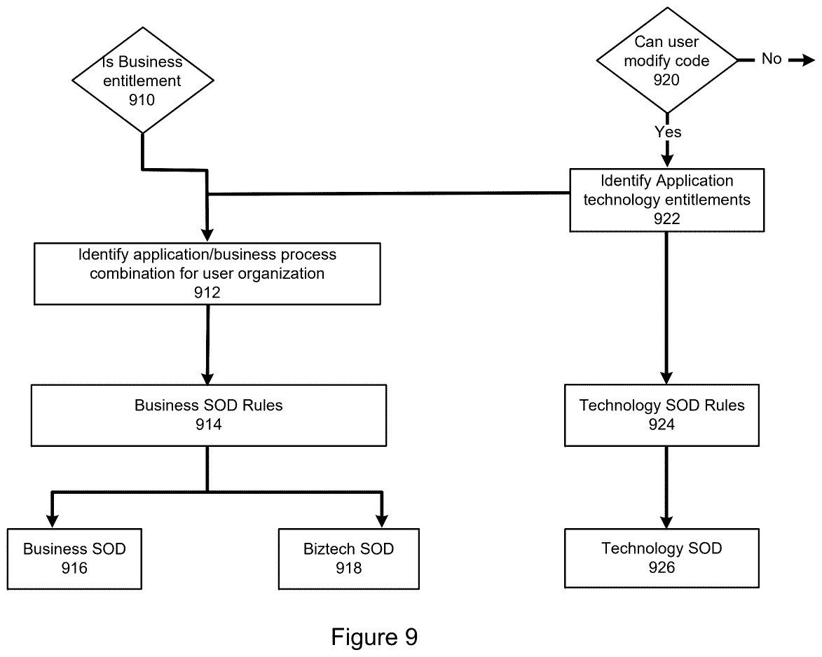

FIG. 9 is an exemplary flowchart, according to an embodiment of the present invention. FIG. 9 illustrates an ability to define and manage rules per different business and technology functions that exist in an entity.

As shown in FIG. 9, step 910 may determine whether the entitlement is a business entitlement. Step 912 may identify application/business process combinations for an entity or a user's user organization. Step 914 may generate and apply business SOD rules including Business SOD 916 and BizTech SOD 918. Step 920 may determine whether the user can modify code. If yes, step 922 may identify application technology entitlements. If no and the role is not determined to modify code, conflicts are not applied and the process may proceed. Step 924 may generate and apply technology SOD rules at Technology SOD Rules 924 (rules specific to Technology SOD) and Technology SOD 926 (Technology SOD Conflict detection process based on 924).

Various rule combinations may include: Business Entitlement Conflict Detection; Technology Entitlement Conflict Detection and Business Conflict resulting from System Entitlements. Other combinations may be supported.

Business Entitlement Conflict Detection may include making determinations between rules such as: Process vs Process Rule; Organization vs Process Rule; etc.

With Technology Entitlement Conflict Detection, developers may have entitlements on production assets and/or sensitive data.

As for Business Conflict resulting from System Entitlement, when a user is provisioned technology entitlements, entitlement models may be created and the mapping of those entitlements with business processes may be generated. Once Business processes associated with user is collected, various processes combinations may be evaluated to determine whether they are creating conflicts or with the organization of user. Such a detection may be flagged as Biztech conflict.

An embodiment of the present invention may be applied to various use cases including business owned rules. For example, an embodiment of the present invention is directed to addressing organization wise entitlement outliers. A cost center outlier may represent a business unit owned analytics-based conflict detection. The engine may perform a clustering of users at a cost center (organization hierarchy) level. Once the scope if defined entitlement grouping of users are performed. Based on the commonality of entitlement in that group is detected (in percentage), the rule to filter out all the user and entitlement falling under defined threshold and flag it as conflict to be reviewed.

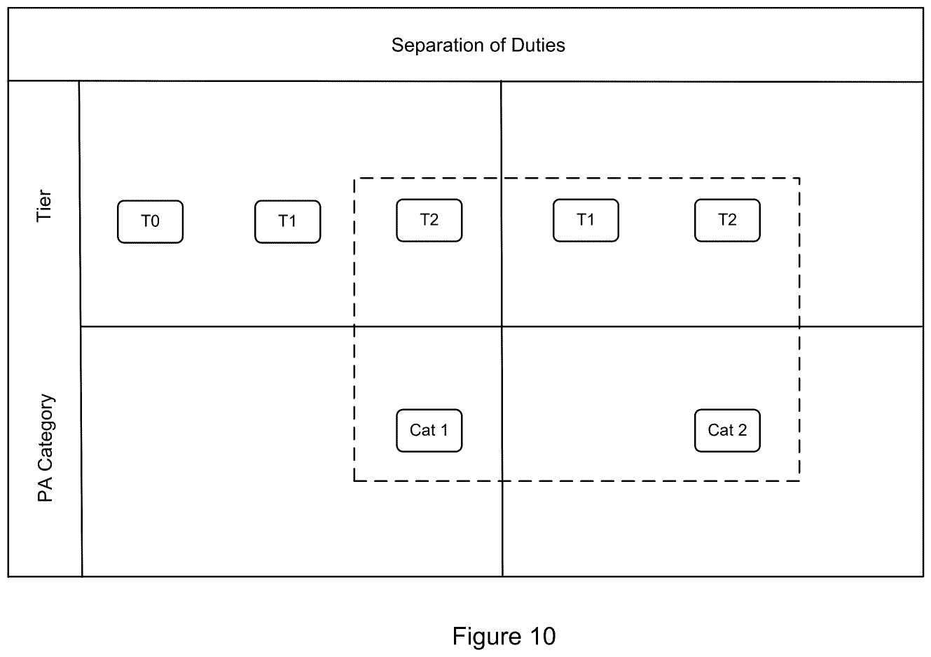

FIG. 10 is an illustration of privileged entitlements conflicts, according to an embodiment of the present invention. FIG. 10 illustrates separation of duties through Tier and PA categories.

A Privileged Access (PA) may provide a user or process the ability to grant access, modify assets (e.g., systems, applications, data) and/or modify controls around assets with broad scope of impact to systems and platforms affecting the Confidentiality, Integrity and/or Availability. Privileged Access entitlements may be used for an administration. Examples may include: UNIX root; database SA entitlements; Active Directory administrative rights; Privileged Control Access Tier; etc.

As shown in FIG. 10, PA critical entitlements may be fenced into tiers based on a tier classification entitlement risk score and/or other metrics. Two low score tiers may be combined in a manner that creates potential risk, e.g., anyone with Tier 1/2 access on Windows that also has a download, write to USB or browse web exception may indicate risk as this person may potentially exploit both these entitlement together. Accordingly, SOD rules may be applied to identify these combinations to reduce potentially high risk scenarios.

An embodiment of the present invention is directed to information barrier conflicts. For example, a user may be provided an information barrier status based on the user's job role. An embodiment of the present invention may extract an entitlement for a user and extract an underlying application classification of the entitlement. If the classification is different material non-public information (MNPI) flag (e.g., Business activity and Client information), any user with a public information barrier status should not be able to access it. MNPI flag may represent corporate news or information that has not yet been made public and which could also have an impact on its share price.

As recognized by an embodiment of the present invention, some entitlements may expose certain types of sensitive data that may be protected by information barrier components. Other types of indirect access points that may potentially expose sensitive data may be considered as well. Accordingly, an embodiment of the present invention may extend to indirect access points and other interactions that may expose certain types of protected information, data, etc.

An embodiment of the present invention may be directed to applying technology controls against business conflicts. A business SOD conflict may involve an ability to book a trade but not being able to clear the trade. In this example, a user may have access to a database that could potentially invoke a set of related business controls. An embodiment of the present invention may be directed to merging technical access with business process functionality. Accordingly, an embodiment of the present invention addresses indirect system access where a user may be indirectly given a business entitlement or access that would otherwise be restricted.

An embodiment of the present invention may be directed to offering self-service for rule governance along with an annual attestation process and change management for the rule's definition changes. A rule visualizer capability may offer options to users for self-service for rule governance, auditable versioning, zero-time deployment of rule definition to production, ServiceNow controlled rule management and attestation process for the rules.

FIG. 11 is an exemplary flowchart, according to an embodiment of the present invention. An embodiment of the present invention recognizes that with the rapid evaluation of digital technologies, businesses face increasing challenges to develop and maintain up-to-date technology policies that comply with regulatory standards, industry best practices and unique organization needs. Significant resources are spent in interpreting these policies, creating rules often lagging behind emerging trends, which increase exposure of compliance risk.

An embodiment of the present invention is directed to a Tool that expands Separation of Duties to cater to these needs by leveraging Generative AI (“GenAI”) to produce customizable, context aware SOD policies.

As shown in FIG. 11, the Tool may web scrap various regulator portals 1110, such as GDPR, HIPAA, SOX, PCI to extract IAM policies at Rule Parsing and Context Analysis Module 1112 to extract SOD policies. The Tool then pass these policies and existing SOD rules templates 1132 as a context 1126 into GenAI 1128 to generate a new SOD rule description, modify existing rules (as shown by 1130) or recommend a change in existing entitlement model. Based on the new SOD rule description, the Tool may create a clustering based on unsupervised learning (e.g., k-means plus and random forest models) to identify entitlement attributes and values which are closer to generated policies. These attributes may be passed as a Context 1134 to GenAI (as shown by 1112) to generate SOD new rules/modify existing rule. SOD calculations, as shown by Classification Model 1118, may be run on these rules and the output may be evaluated and also stored in Entitlement Database 1120. Matrix Evaluation 1124 (e.g., major Matrix based on Accuracy, Precision, Recall, F1 Score, ROC Curve and AUC, Confusion Matrix, etc.) may evaluate the model and modify the model based on matrix feedback. As shown by FIG. 11, Policy Engine 1122 provides up-to-date technology policies that comply with regulatory standards, industry best practices and unique organization needs.

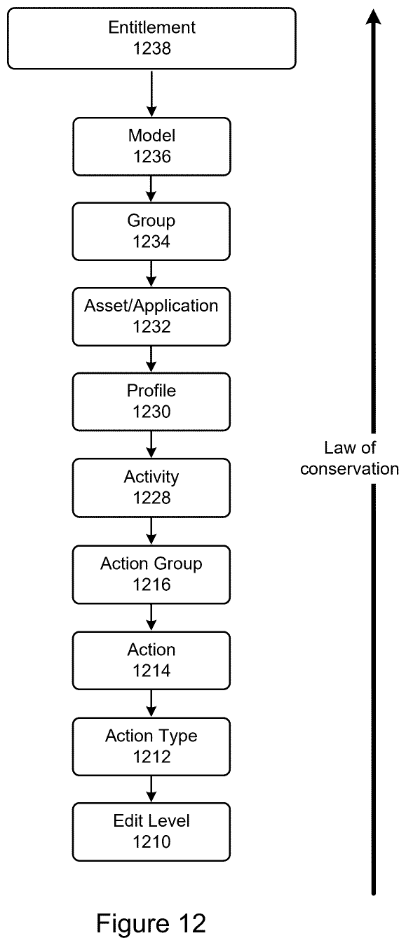

FIG. 12 is an exemplary diagram, according to an embodiment of the present invention. FIG. 12 illustrates how an entitlement model may be defined.

According to an exemplary illustration, Edit Level 1210 may represent basic read/write functions. Action Type 1212 may represent a specific action or function as shown by 1214. Action Group 1216 may represent groups of actions. These groups may then be represented as an Activity 1228. Under Profile 1230, different activities that a specific user may perform may be identified. Profiles may be matched to an Asset or Application, as shown by 1232. Multiple assets may be grouped together (as shown by Group 1234) for a particular entitlement 1238, which may be mapped and modeled as shown by 1236.

According to an embodiment of the present invention, Entitlements may represent a combination and hierarchy of Asset, Environment, Profile, Activity, Action, Edit Level and Business Process assigned to a user and/or a role. A model may simplify the complex entitlement hierarchy to resolve a Business Process, Environment and Edit Level information for entitlement based on a law of conservation, which enables the rules to be implemented on these entitlements.

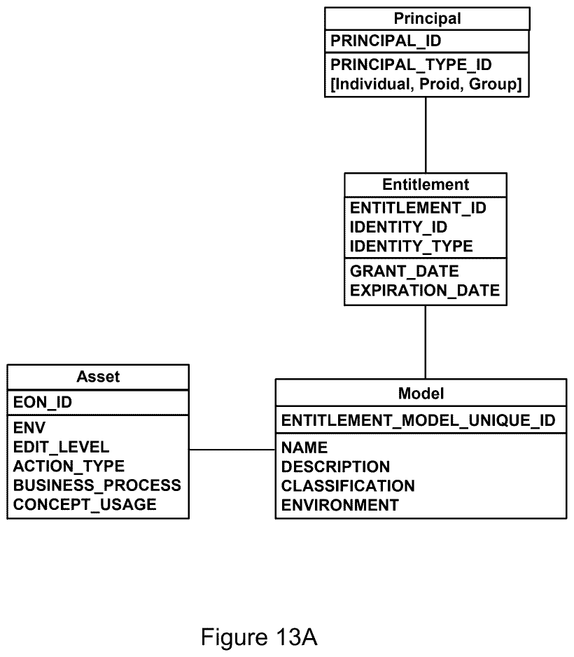

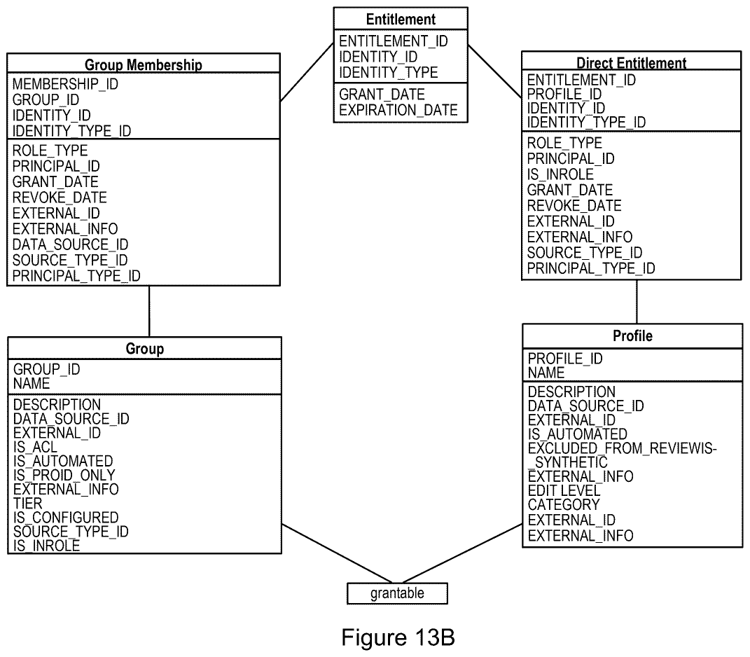

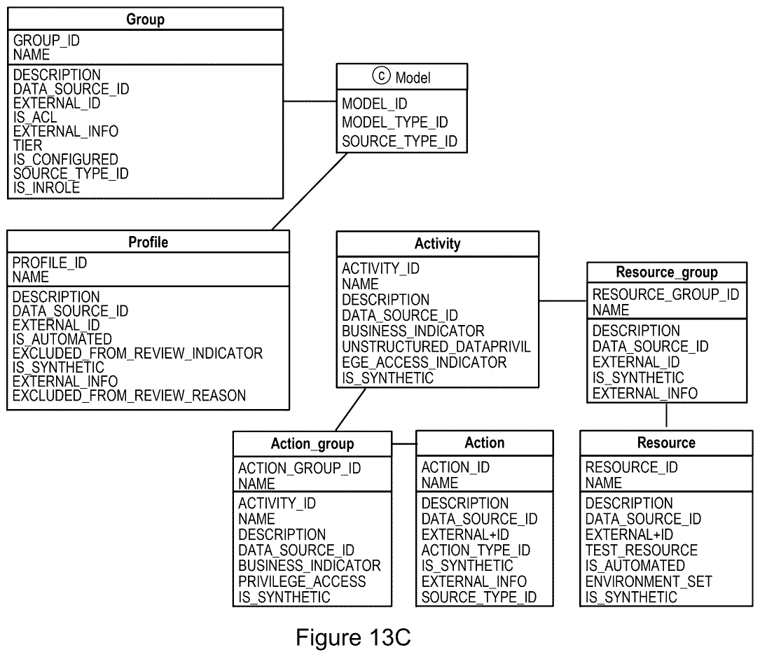

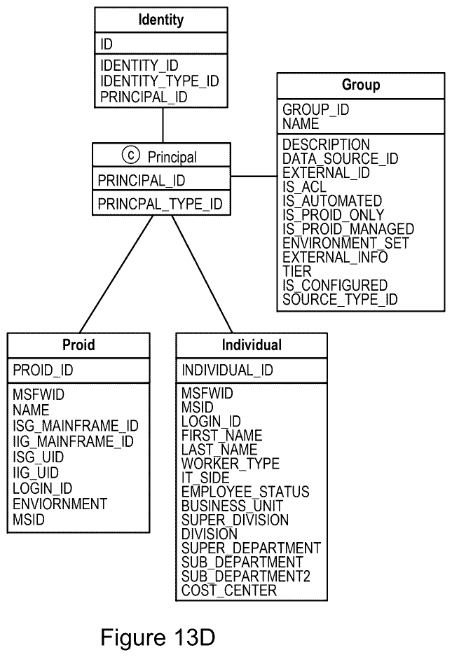

FIGS. 13A-D illustrate exemplary data structures, according to an embodiment of the present invention. FIG. 13A illustrates an Entitlement Model Overview. FIG. 13B illustrates an Entitlement Subject Area. FIG. 13C illustrates a Model Subject Area. FIG. 13D illustrates a Principal Subject Area.

An embodiment of the present invention is directed to entitlements based on a law of conservation. Entitlement models may create a linear/acyclic hierarchy of entitlement objects in an order shown FIGS. 13-16.

For business entitlements, there is an entitlement level classification that determines what are eligible business entitlements. Important attributes for Business SOD conflict detection may include: a Business process taxonomy hierarchy, an Organization hierarchy of human user, an environment of entitlement profile based on asset classification edit level of business process and role of the user. Environments may be defined at an asset level based on system classifications. Entitlements may be hierarchical in nature so that a model may then calculate an environment rollup from underlying assets for an entitlement.

For example, if an entitlement has more than one asset and one or more of them is a production application then by applying the law of conservation, the top level entitlement environment becomes production similarly business process are mapped to one or more than one entitlements. An embodiment of the present invention may then perform reverse mapping to find flattened business processes under an entitlement and roll up edit level of business process and edit level at entitlement model level and apply law of conservation so if one of edit level is write access then model get write classification.

For Technology entitlements user who have modify code privilege and tagged as developer role and scoped for calculation. Important attributes in the calculation may include: Environment, Edit Level, Data Sensitivity, Sox Flag for application. Environment, Sox may represent an application flag and edit level are activity and action type flag. These flags may be resolved by aggregating (max logic) to entitlement level and calculated.

There are also application and entitlement flags which validate if a position is eligible for review based on application/entitlement processes is there a control process in process or if it is an automated process.

An embodiment of the present invention is directed to a system architecture that incorporates an AI-based SOD Text Assistant Chatbot directly within a SOD review interface to optimize and automate user interactions throughout the SOD review lifecycle. The AI-based SOD Text Assistant Chatbot may be implemented in a user interface, as shown by Output User Interface 344 and Review 346 described above in connection with FIG. 3. The SOD Text Assistant Chatbot may be integrated at the application layer, facilitating direct manipulation of application state and supporting automated population of form fields. Contextual awareness may be provided by dynamically extracting runtime context from the application, thereby enabling the SOD Text Assistant Chatbot to infer user actions and information needs.

For advanced semantic retrieval and contextual relevance, an embodiment of the present invention may preprocess relevant textual data into segments (e.g., 512-byte segments), which may be subsequently converted into vector embeddings using similarity metrics, such as cosine similarity metrics. These embeddings may be stored within a high-performance vector database. Upon receiving a user query or interaction, an embodiment of the present invention may utilize a similarity search (e.g., FAISS (Facebook AI Similarity Search), etc.) to efficiently perform similarity searches and clustering operations on the dense vector representations. The top relevant vector matches may be selected and combined with the real-time application context before being passed to an AI API, such as OpenAI ChatGPT API. This enables the SOD Text Assistant Chatbot to deliver precise, context-sensitive natural language responses within the SOD review workflow.

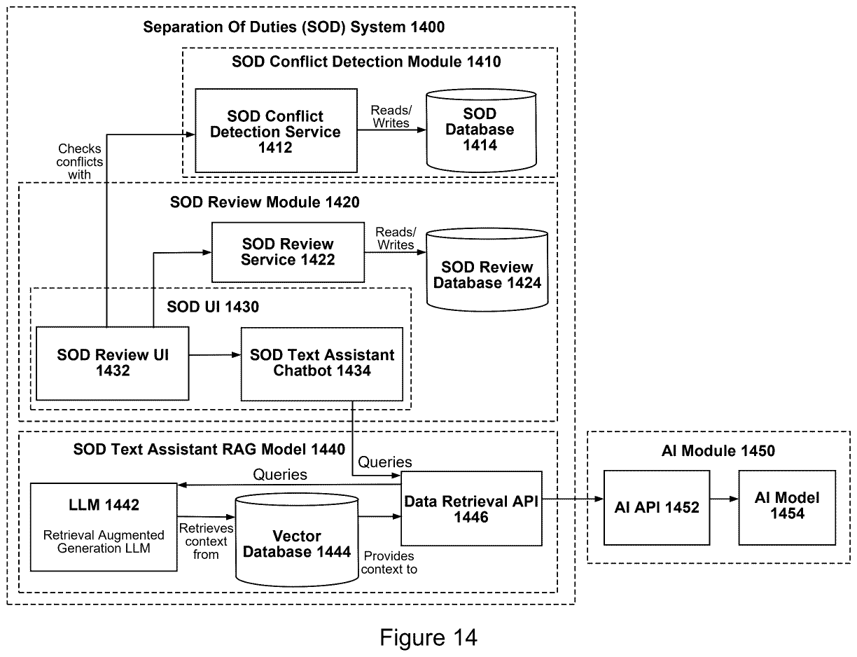

FIG. 14 is an exemplary system diagram, according to an embodiment of the present invention. As shown in FIG. 14, a Separation of Duties System 1400 may be configured to manage conflict detection and resolution processes within organizational access control frameworks. The Separation of Duties System 1400 may include a SOD Conflict Detection Module 1410, a SOD Review Module 1420, a SOD User Interface (“UI”) 1430, a SOD Text Assistant RAG Model 1440, and an AI Module 1450. These components may work together to provide comprehensive conflict management capabilities with enhanced user guidance through artificial intelligence-powered assistance. These components may be implemented in various architectures and configurations.

SOD Conflict Detection Module 1410 may include a SOD Conflict Detection Service 1412 that may be configured to detect and analyze potential conflicts within user access permissions and organizational roles. SOD Conflict Detection Service 1412 may perform read and write operations with SOD Database 1414, which may store conflict-related data, rules and/or historical information. In addition, SOD Database 1414 may maintain records of detected conflicts, rule violations and/or associated metadata to support the conflict resolution process.

SOD Review Module 1420 may include SOD Review Service 1422 that may facilitate the evaluation and resolution of detected conflicts. SOD Review Service 1422 may perform read and write operations with SOD Review Database 1424, which may store review decisions, justifications, audit trails, etc. In addition, SOD Review Database 1424 may maintain comprehensive records of reviewer actions, exception approvals and/or associated documentation to support compliance and auditing requirements.

SOD User Interface (“UI”) 1430 may contain SOD Review UI 1432 that may provide a platform for users to interact with the conflict resolution system. SOD Review UI 1432 may connect to an AI-based SOD Text Assistant Chatbot 1434, which may be embedded directly into the separation of duties review platform. In other examples, SOD Text Assistant Chatbot 1434 may operating as a standalone application. SOD Text Assistant Chatbot 1434 may provide contextual assistance to users during the conflict resolution process, offering guidance on form completion, field explanations, comment quality assessment, etc.

SOD Text Assistant RAG Model 1440 may include large language models (LLM) 1442 that provides retrieval augmented generation LLM that implements language model functionality for processing user queries and generating contextual responses. LLM 1442 may retrieve context information from Vector Database 1444, which may store embeddings and documents related to separation of duties knowledge and organizational policies. Data Retrieval API 1446 may handle data retrieval operations for retrieval augmented generation processes and may receive context information Vector Database 1444.

AI Module 1450 may include an AI API 1452 that operates with AI Model 1454 for advanced natural language processing capabilities. AI API 1452 may represent various Generative AI services. SOD Text Assistant Chatbot 1434 may send queries through Data Retrieval API 1446, which may interface with AI Module 1450 to process and respond to user interactions. AI Model 1454 may communicate with external language model services through AI integration, such as OpenAI API integration, enabling SOD Text Assistant Chatbot 1434 to generate responses based on stored knowledge, real-time contextual information and/or other situational and relevant information from the review process.

According to an exemplary illustration, the SOD Text Assistant Chatbot 1434 may use OpenAI API for communicating with the LLM 1442 and hierarchal navigable small world-vector indexing with dense embeddings pre-generated from a knowledge base as the basis for the retrieval augmented generation system, while the UI uses the angular framework.

An embodiment of the present invention is directed to a SOD Text Assistant Chatbot that provides a modular, context-aware solution by leveraging Generative AI technology. The SOD Text Assistant Chatbot provides advanced handling of free-text input fields. Utilizing natural language processing algorithms and GenAI technology, the SOD Text Assistant Chatbot systematically analyzes user input to assess completeness, specificity and/or relevance to detect entries that are incomplete, ambiguous, or insufficient as well as identify cases where input is clear but contextually irrelevant.

Within the Separation of Duties (SOD) conflict detection and resolution framework, the SOD Text Assistant Chatbot provides dynamic guidance, prompting users to supply more precise and actionable information. The response generation logic is configurable, allowing customization to align with organizational requirements. The SOD Text Assistant Chatbot also maintains session state and conversational history, enabling persistent context across multiple user interactions for a more cohesive experience. An embodiment of the present invention delivers in-depth explanations for form fields, dropdown menus, and their selectable options, thereby ensuring users have a comprehensive understanding of each data element involved in the SOD review process.

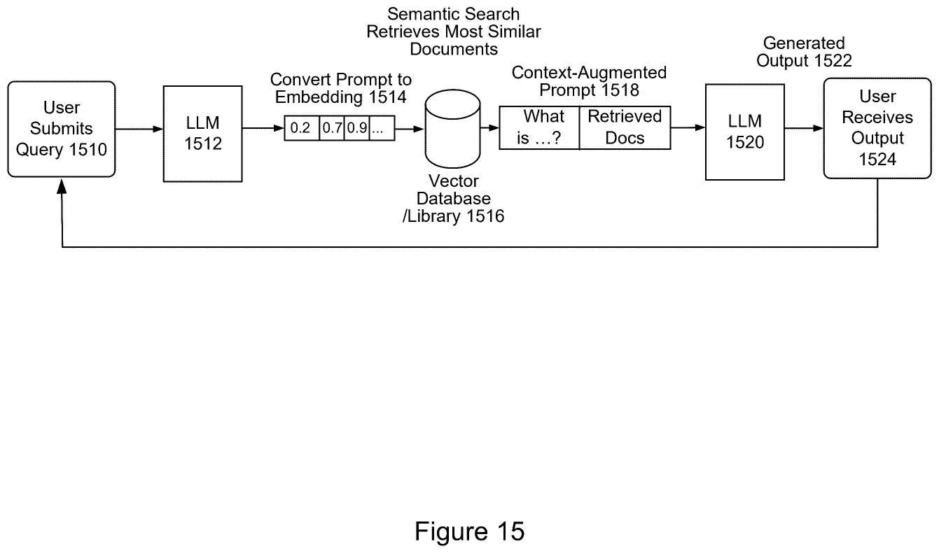

FIG. 15 is an exemplary flowchart, according to an embodiment of the present invention. An embodiment of the present invention is directed to a query processing flow that enables contextual response generation through retrieval augmented generation techniques. At 1510, a user may submit a query to the system. The user query may be received by a large language model (LLM) 1512, which may be configured to process natural language input from users interacting with the separation of duties review platform. LLM 1512 may convert the user query into an Embedding 1514, which may represent the semantic content of the query in a numerical vector format suitable for similarity comparison operations. Other vector-based formats may be used.

The Embedding 1514 may be used to search Vector Database 1516 that stores pre-processed embeddings derived from the separation of duties knowledge base. Vector Database 1516 may utilize a similarity search technology (e.g., FAISS (Facebook AI Similarity Search), etc.) for efficient similarity search and clustering of dense vectors, enabling rapid identification of relevant contextual information. An embodiment of the present invention may provide computational efficiency when searching through large collections of embedded knowledge base content.

According to an exemplary illustration, an embodiment of the present invention may create 512 byte chunks from the knowledge base before generating embeddings for storage in the vector database. This chunking process may divide larger documents and knowledge base entries into smaller, more manageable segments that may be individually embedded and indexed. The 512 byte chunk size may provide a balance between contextual completeness and processing efficiency, allowing the system to maintain semantic coherence while enabling granular retrieval of relevant information.

An embodiment of the present invention may perform retrieval operations to identify similar embeddings from Vector Database 1516 based on Embedding 1514. This may retrieve a top set (e.g., the top 10) of the most similar embeddings from Vector Database 1516, providing a focused set of contextually relevant information for response generation. These retrieved embeddings may correspond to text chunks that may be combined with the original user query, as shown by 1510, to create a context-augmented prompt 1518.

The context-augmented prompt 1518 may contain the original user query 1510 and the contextual information retrieved from Vector Database 1516, providing a comprehensive input for response generation. LLM 1520 may process context-augmented prompt 1518 to then provide Generated Output 1522 that may incorporate the user's specific question and relevant background information from the knowledge base. Generated Output 1522 may be provided to the user as shown by 1524, completing the query processing cycle. This process may enable iterative interaction, as users may submit additional queries based on the responses received, creating a conversational flow that enhances the user experience during separation of duties review processes.

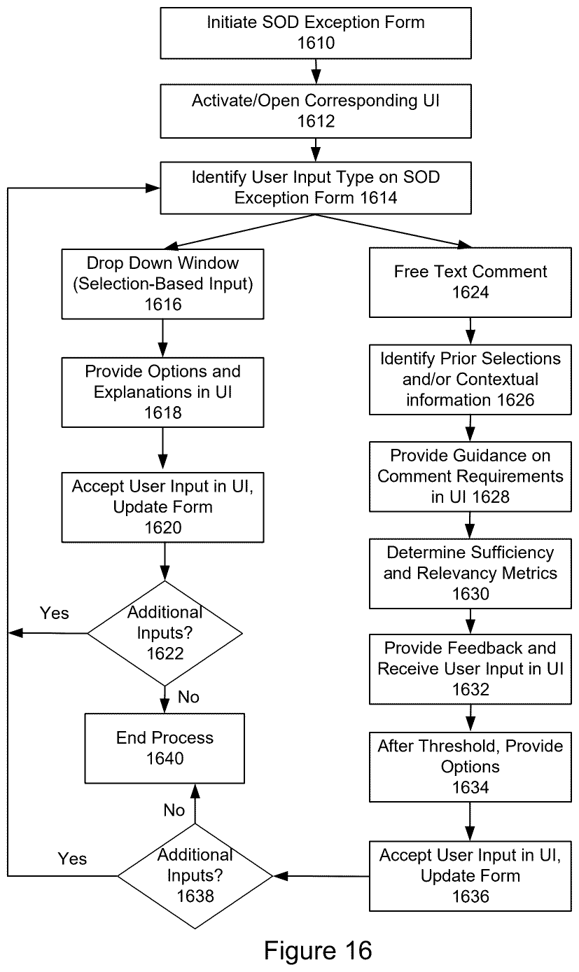

FIG. 16 is an exemplary flowchart, according to an embodiment of the present invention. As shown in FIG. 16, an embodiment of the present invention may implement an exception form processing workflow that handles various types of user input through structured decision paths.

At step 1610, the system may initiate a SOD exception form for conflict resolution processes. Step 1610 may be integrated in a review process when an entitlement is maintained, as shown in FIG. 5 (Conflict Review 560), FIG. 6 (Maintain as a proposed exception), FIG. 8 (Maintain Step 810), as discussed above.

Following initiation, the process may proceed to step 1612, where the system may activate and open a corresponding user interface that may provide guidance to the exception form functionality. The corresponding user interface may execute a SOD Text Assistant Chatbot to support and guide the user through the SOD exception form.

At step 1614, the system may identify the user input type on the SOD exception form. This identification process may determine whether the user interaction involves dropdown selections, free text input, or other form elements, enabling the system to provide appropriate guidance and processing for each input type.

At step 1614, the workflow may follow two distinct processing paths based on the identified input type. Additional processing paths may be supported based on the type of user input. In cases where the user may select from a predetermined set of options (such as a dropdown selection input), the process may proceed to step 1616. At step 1618, a SOD text assistant chatbot may provide options and explanations in the user interface. The SOD text assistant chatbot may offer detailed descriptions of dropdown options, field meanings and/or contextual information to assist users in making informed selections. At step 1620, the system may accept user input in the user interface and update the form accordingly. The text assistant chatbot may support bidirectional text input functionality, allowing users to enter selections either through direct interaction with dropdown elements or through the chat interface, with synchronized updates occurring across both input methods. Following form updates, the process may proceed to step 1622, which may serve as a decision point to determine whether additional inputs may be needed for form completion. If there are not additional inputs, the process ends at step 1640.

For free text input scenarios, the workflow may proceed to step 1624 to handle free text comment input processing. At step 1626, an embodiment of the present invention may identify prior selections and contextual information to support situational awareness capabilities. For example, a AI module may access current form data, user selections, conflict context, and/or rule information to provide contextually relevant guidance that may align with the specific circumstances of the conflict being reviewed.

At step 1628, the SOD text assistant chatbot may provide guidance on comment requirements in the user interface. The SOD text assistant chatbot may maintain conversation context by remembering previous interactions throughout the form completion process, enabling the system to provide coherent and contextually appropriate assistance that may build upon earlier exchanges with the user.

At step 1630, an embodiment of the present invention may determine sufficiency and relevancy metrics for the provided text input. The text assistant chatbot may analyze user comments against predefined standards and contextual requirements, evaluating whether the provided information may meet quality thresholds for audit and compliance purposes. At step 1632, an embodiment of the present invention may provide feedback and support user interactions, enabling iterative improvement of comment quality through guided interaction.

At step 1634, an embodiment of the present invention may provide options after reaching a threshold number of unsuccessful attempts. These options may include submitting the current comment with warnings, modifying the comment for improvement, or receiving AI-generated comments based on contextual analysis. Other options and variations may be implemented. The workflow may then proceed to a step 1636, where the system may accept user input in the user interface and update the form with the finalized comment content.

An embodiment of the present invention may determine whether additional inputs may be needed to complete the form processing at step 1622 and step 1638. When additional inputs may be required, both paths may return to the step 1614 to identify the next user input type, enabling comprehensive processing of complex exception forms with multiple input requirements. When no additional inputs may be needed, the workflow may conclude at step 1640, having successfully processed all form elements with appropriate guidance and validation through the text assistant chatbot and associated system components.

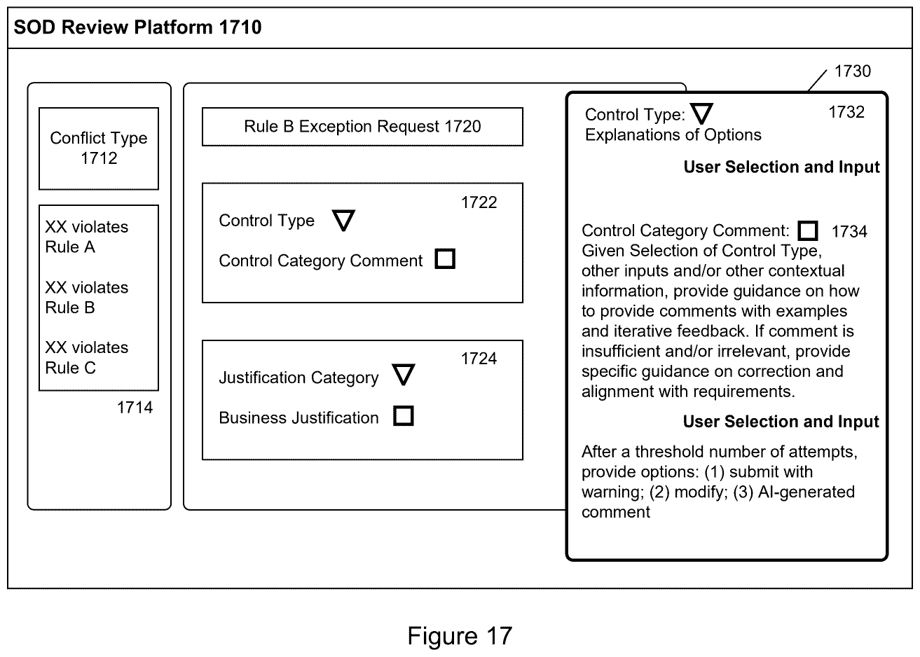

FIG. 17 is an exemplary interface, according to an embodiment of the present invention. As shown in FIG. 17, SOD Review Platform 1710 may provide a comprehensive interface for managing separation of duties conflict resolution processes. SOD Review Platform 1710 may include a conflict type section 1712, an exception request section 1720, and a guidance interface 1730, which may work together to facilitate structured conflict review and exception documentation. According to an exemplary illustration, SOD Review Platform 1710 may implement the Angular framework for user interface functionality, providing responsive and interactive interface elements that may support the chat-based assistance system integration. Other frameworks may be implemented.

Conflict Type Section 1712 may display a rule violation list 1714 that may present specific rule violations such as Rule A, Rule B, and Rule C violations. The rule violation list 1714 may provide reviewers with clear identification of the conflicts that may require resolution, enabling focused attention on the specific regulatory or policy violations that may have been detected by a conflict detection service.

Exception Request Section 1720 may include user inputs, as shown by control input section 1722 and a justification input section 1724, which enable users to document their exception requests with appropriate controls and supporting rationale. The control input section 1722 may provide structured input fields for specifying control types through a drop down window. Control input section 1722 may also include free text input through control category comment and other inputs that may address the identified conflicts. The justification input section 1724 may provide structured input fields for specifying justification categories through a drop down window. In addition, a free text input may be provided for a business justification section where users may provide detailed explanations and rationale for their exception requests.

As further shown in FIG. 17, the SOD Text Assistant Chatbot may execute on Guidance Interface 1730. In this illustration, Guidance Interface 1730 includes a user selection guidance section at 1732 and a comment guidance section 1734, which may provide interactive assistance throughout the exception documentation process. User selection guidance section 1732 may enable automatic form filling functionality where users may select dropdown options within the guidance UI 1730 that may automatically populate corresponding form fields in the control input section 1722. This bidirectional interaction capability may allow users to make selections through the guidance interface 1730 while maintaining synchronized updates across the review platform 1710.

The comment guidance section 1734 may provide iterative feedback and guidance based on the selection of control type and other contextual information from the exception request section 1720. An embodiment of the present invention may analyze comment quality against predefined standards that may include classifications, assets, and/or other criteria defined by product owners. These predefined standards may serve as benchmarks for evaluating whether user-provided justifications may meet organizational requirements for audit and compliance purposes.

When comments may be determined to be insufficient or irrelevant through the quality analysis process, the comment guidance section 1734 may provide specific guidance on correction and alignment with requirements. An embodiment of the present invention may evaluate user input against the contextual information from the control input section 1722 and may identify misalignments between selected control types and provided justifications.

After a threshold number of unsuccessful attempts to provide adequate comments, the comment guidance section 1734 may present a set of intervention options to users. The first option may allow users to submit the current comment with a warning notification, where the guidance interface 1730 may warn users that inadequate comments will be highlighted to approvers during the review process. The second option may enable users to modify their comment, providing another opportunity to improve the quality and relevance of their justification. The third option may offer AI-generated comments through a guided question process, where the text assistant chatbot may ask a series of questions and may utilize conflict context, form data, and other factors to generate clear and detailed comments that may align with the selected control measures and organizational standards. Other options and variations may be implemented.

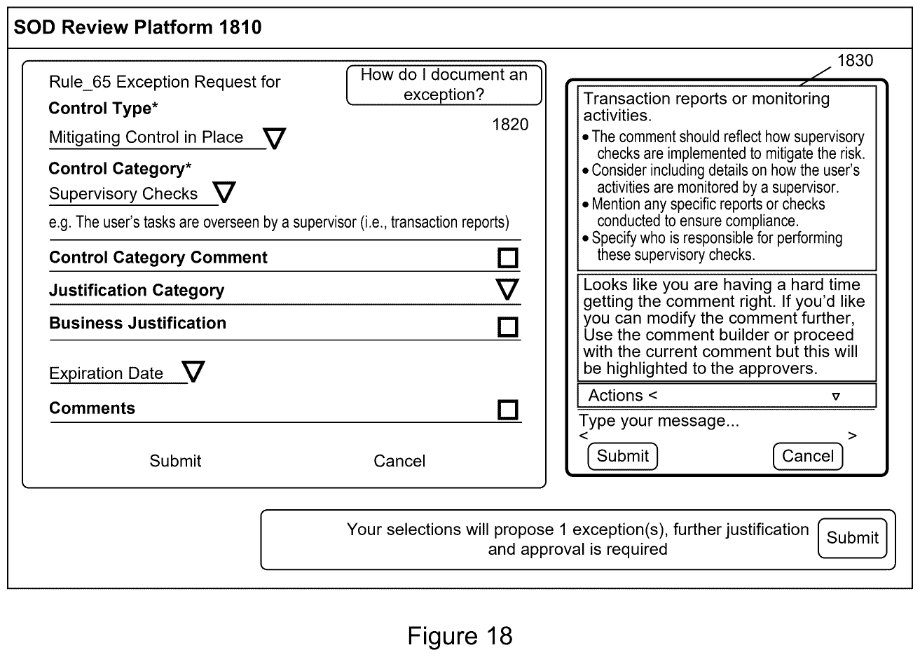

FIG. 18 is an exemplary interface, according to an embodiment of the present invention. As shown in FIG. 18, a SOD Review Platform 1810 may provide a user interface layout that enables users to interact with conflict resolution processes through structured visual elements.

SOD Review Platform 1810 may include an exception documentation section 1820 that displays fields for entering control type, control category, and other exception-related information. The exception documentation section 1820 may provide structured input areas where users may document their conflict resolution decisions and supporting rationale.

As further shown in FIG. 18, SOD Review Platform interface 1810 may include a guidance window 1830 displayed adjacent to the exception documentation section 1820. The monitoring guidance window 1830 provides guidance by offering contextual assistance that aligns with the user's current form completion activities where the SOD Text Assistant Chatbot may execute on monitoring guidance window 1830.

For example, a reviewer may select a control type as “Mitigating Control In Place” and a control category to be “supervisory checks” while providing the control category comment as “Risk is mitigated automatically for this conflict by the user.” An embodiment of the present invention may detect that the comment does not substantiate the options selected and does not provide a clear and detailed rationale. According to another example, the reviewer may provide a more mature and detailed comment, but the information is irrelevant to both selected control type “Mitigating Control In Place” and control category “supervisory checks.”

According to an exemplary illustration, the Angular framework implementation may provide the underlying technology infrastructure for the interactive interface elements within the SOD Review Platform. The Angular framework may enable bidirectional data binding between the exception documentation prompts and the monitoring guidance window, allowing synchronized updates when users may interact with either interface component. This framework integration may support the real-time interaction capabilities of the SOD text assistant chatbot, enabling seamless communication between user inputs and AI-generated guidance responses. The framework implementation may support the embedded chatbot functionality by providing the necessary interface components for displaying contextual guidance, processing user interactions, and presenting AI-generated responses within the unified SOD review platform interface.

An embodiment of the present invention is directed to providing specific technical improvements to computer-based conflict resolution platforms through the integration of artificial intelligence-enhanced text assistance capabilities. The system addresses technical challenges in digital form processing by implementing a retrieval augmented generation architecture that combines vector database search functionality with large language model processing to provide contextually relevant guidance for free-text input and other fields.

According to an embodiment of the present invention, a SOD text assistant implements a technical solution for improving data quality in enterprise software systems through automated analysis of user input completeness and relevance. A vector database may store pre-processed embeddings generated from organizational knowledge bases, enabling efficient similarity searches using cosine similarity metrics to identify contextually relevant information. A retrieval generation model may process user queries by converting natural language input into numerical vector representations that may be compared against stored embeddings to retrieve relevant document chunks.

An embodiment of the present invention leverages AI models to provide computer-specific functionality that implements a chat interface that processes augmented prompts combining original user queries with retrieved contextual information. AI models may generate responses specifically tailored to a current form context, user selections and/or organizational standards thereby providing technical improvements over static guidance systems that are incapable of adapting to specific user circumstances and other situational data.

An embodiment of the present invention may implement bidirectional data synchronization between the text assistant chatbot and structured form elements, enabling automatic population of form fields based on chat interactions while maintaining data consistency across interface components. The Angular framework implementation may provide responsive user interface management with real-time updates between the exception documentation prompt and monitoring guidance window, supporting seamless integration of AI-generated guidance within existing enterprise software platforms.

The technical architecture may address computational efficiency challenges through the implementation of FAISS similarity search technology for vector database operations, enabling rapid processing of large-scale document embeddings. The system may utilize knowledge base content to optimize embedding generation and retrieval operations, providing a balance between contextual completeness and processing performance in enterprise computing environments.

The system components are exemplary and illustrative, an embodiment of the present invention may interact with additional modules, a combination of the modules described and/or less modules than illustrated. While a single illustrative block, module or component is shown, these illustrative blocks, modules or components may be multiplied for various applications or different application environments. In addition, the modules or components may be further combined into a consolidated unit. The modules and/or components may be further duplicated, combined and/or separated across multiple systems at local and/or remote locations. Other architectures may be realized.

The illustrated system may be communicatively coupled to various Data Stores as well as remote storages. Data stores may also store and maintain source code, reports, performance data, historical data, etc. These storage components may include any suitable data structure to maintain the information and allow access and retrieval of the information. The storage may be local, remote, or a combination. The storage components may have back-up capability built-in. Communications with the storage components may be over a network or communications may involve a direct connection between the various storage components. The storage components may also represent cloud or other network based storage.

The system may be implemented in a variety of ways. Architecture within the system may be implemented as hardware components (e.g., module) within one or more network elements. It should also be appreciated that architecture within the system may be implemented in computer executable software (e.g., on a tangible, non-transitory computer-readable medium) located within one or more network elements. Module functionality of architecture within the system may be located on a single device or distributed across a plurality of devices including one or more centralized servers and one or more mobile units or end user devices. The architecture depicted in the system is meant to be exemplary and non-limiting. For example, while connections and relationships between the elements of system are depicted, it should be appreciated that other connections and relationships are possible. The system described may be used to implement the various methods herein, by way of example. Various elements of the system may be referenced in explaining the exemplary methods described herein.

Networks may be a wireless network, a wired network or any combination of wireless network and wired network. Networks may further include one, or any number of the exemplary types of networks operating as a stand-alone network or in cooperation with each other. Networks may utilize one or more protocols of one or more network elements to which it is communicatively coupled. Networks may translate to or from other protocols to one or more protocols of network devices. Although Networks may be depicted as one network for simplicity, it should be appreciated that according to one or more embodiments, Networks may comprise a plurality of interconnected networks, such as, for example, a service provider network, the Internet, a cellular network, corporate networks, or even home networks, or any of the types of networks mentioned above.

Data may be transmitted and received via Networks utilizing a standard networking protocol or a standard telecommunications protocol. For example, data may be transmitted using protocols and systems suitable for transmitting and receiving data. Data may be transmitted and received wirelessly or in some cases may utilize cabled network or telecom connections or other wired network connection.

While the figures illustrate individual devices or components, it should be appreciated that there may be several of such devices to carry out the various exemplary embodiments. The system may communicate using any mobile or computing device, such as a laptop computer, a personal digital assistant, a smartphone, a smartwatch, smart glasses, other wearables or other computing devices capable of sending or receiving network signals. Computing devices may have an application installed that is associated with the illustrated system.

Those skilled in the art will appreciate that the diagrams discussed above are merely examples of a system and a method for implementing a separation of duties based conflict detection and resolution platform. Other types and configurations of networks, servers, databases and personal computing devices (e.g., desktop computers, tablet computers, mobile computing devices, smart phones, etc.) may be used with exemplary embodiments of the invention.

Although the foregoing examples show the various embodiments of the invention in one physical configuration, it is to be appreciated that the various components may be located at distant portions of a distributed network, such as a local area network, a wide area network, a telecommunications network, an intranet and/or the Internet. Thus, it should be appreciated that the components of the various embodiments may be combined into one or more devices, collocated on a particular node of a distributed network, or distributed at various locations in a network, for example. The components of the various embodiments may be arranged at any location or locations within a distributed network without affecting the operation of the respective system.

Although examples of servers, databases, and personal computing devices have been described above, exemplary embodiments of the invention may utilize other types of devices whereby a user may interact with a network that transmits and delivers data and information used by the various systems and methods described herein. These devices may further include an electronic memory such as a random access memory (RAM), electronically programmable read only memory (EPROM), other computer chip-based memory, a hard drive, or other magnetic, electrical, optical or other media, and other associated components connected over an electronic bus, as will be appreciated by persons skilled in the art.

In some embodiments, the computing devices may be equipped with an integral or connectable liquid crystal display (LCD), electroluminescent display, a light emitting diode (LED), organic light emitting diode (OLED) or another display screen, panel or device for viewing and manipulating files, data and other resources, for instance using a graphical user interface (GUI) or a command line interface (CLI). The personal computing devices may also include a network-enabled appliance or another TCP/IP client or other device.

The servers, databases, and personal computing devices described above may include at least one accelerated processing unit, such as a GPU or FPGA, and at least one memory or storage device. The memory may store a set of instructions. The instructions may be either permanently or temporarily stored in the memory or memories of the processor. The set of instructions may include various instructions that perform a particular task or tasks, such as those tasks described above. Such a set of instructions for performing a particular task may be characterized as a program, software program, software application, app, or software. The modules described above may comprise software stored in the memory (e.g., non-transitory computer readable medium containing program code instructions executed by the processor) for executing the methods described herein.

Any suitable programming language may be used in accordance with the various embodiments of the invention. For example, the programming language used may include assembly language, Ada, APL, Basic, C, C++, dBase, Forth, HTML, Android, iOS, .NET, Python, Java, Modula-2, Pascal, Prolog, REXX, Visual Basic, and/or JavaScript. Further, it is not necessary that a single type of instructions or single programming language be utilized in conjunction with the operation of the system and method of the invention. Rather, any number of different programming languages may be utilized as is necessary or desirable.

The software, hardware and services described herein may be provided utilizing one or more cloud service models, such as Software-as-a-Service (SaaS), Platform-as-a-Service (PaaS), Infrastructure-as-a-Service (IaaS), and Logging as a Service (LaaS), and/or using one or more deployment models such as public cloud, private cloud, hybrid cloud, and/or community cloud models.

In the system and method of exemplary embodiments of the invention, a variety of “user interfaces” may be utilized to allow a user to interface with the personal computing devices. As used herein, a user interface may include any hardware, software, or combination of hardware and software used by the processor that allows a user to interact with the processor of the communication device. A user interface may be in the form of a dialogue screen provided by an app, for example. A user interface may also include any of touch screen, keyboard, voice reader, voice recognizer, dialogue screen, menu box, list, checkbox, toggle switch, a pushbutton, a virtual environment (e.g., Virtual Machine (VM)/cloud), or any other device that allows a user to receive information regarding the operation of the processor as it processes a set of instructions and/or provide the processor with information. Accordingly, the user interface may be any system that provides communication between a user and a processor.

Although the embodiments of the invention have been described herein in the context of a particular implementation in a particular environment for a particular purpose, those skilled in the art will recognize that its usefulness is not limited thereto and that the embodiments of the invention can be beneficially implemented in other related environments for similar purposes.

The foregoing description, along with its associated embodiments, has been presented for purposes of illustration only. It is not exhaustive and does not limit the invention to the precise form disclosed. Those skilled in the art may appreciate from the foregoing description that modifications and variations are possible in light of the above teachings or may be acquired from practicing the disclosed embodiments. For example, the steps described need not be performed in the same sequence discussed or with the same degree of separation. Likewise various steps may be omitted, repeated, or combined, as necessary, to achieve the same or similar objectives. Accordingly, the invention is not limited to the above-described embodiments, but instead is defined by the appended claims in light of their full scope of equivalents. The specification and drawings are accordingly to be regarded as an illustrative rather than restrictive sense.

What is claimed is:

1. A separation of duties (SOD) based conflict detection and resolution system comprising:
a computer server comprising one or more processors;
an interactive user interface that receives one or more user inputs; and
non-transitory memory comprising instructions that, when executed by the one or more processors, cause the one or more processors to:
initiate, via the interactive user interface, a SOD exception interface executing on the SOD conflict detection and resolution system;
activate, via the interactive user interface, a text assistant chatbot corresponding to the SOD exception interface;
receive, via the text assistant chatbot, one or more queries associated with a user input type relating to the SOD exception interface;
transmit, via the text assistant chatbot, the one or more queries to a data retrieval interface that is communicatively coupled to a retrieval augmented generation large language model and a vector database that provides real-time contextual information and further communicatively coupled to an artificial intelligence model that generates an AI-based response using the real-time contextual information;
identify, via the interactive user interface, the user input type on the SOD exception interface as a selection-based input or a free-text input;
responsive to the user input type, identify one or more prior selections and the real-time contextual information;
provide, via the text assistant chatbot, text guidance based on the one or more prior selections, the real-time contextual information and the AI-based response; and
synchronize one or more interactions via the text assistant chatbot with one or more inputs on the interactive user interface.

2. The separation of duties system of claim 1, wherein the text assistant chatbot is configured to analyze free-text input with respect to one or more sufficiency and relevance metrics.

3. The separation of duties system of claim 1, wherein the text assistant chatbot is configured to provide iterative feedback when the free-text input fails to meet one or more quality thresholds.

4. The separation of duties system of claim 1, wherein the vector database stores embeddings that represent semantic content of the one or more queries in a numerical vector format suitable for similarity comparison operations.

5. The separation of duties system of claim 1, wherein the retrieval augmented generation large language model is configured to perform one or more similarity searches.

6. The separation of duties system of claim 5, wherein the one or more similarity searches use cosine similarity metrics to identify relevant document chunks.

7. The separation of duties system of claim 1, wherein the text assistant chatbot is configured to maintain conversation context across multiple user interactions within a single form session.

8. The separation of duties system of claim 1, further comprising a threshold mechanism configured to present alternative options after a predetermined number of insufficient comment attempts.

9. The separation of duties system of claim 8, wherein the alternative options comprise: submitting current comments with warnings, modifying comments with additional guidance, and generating artificial intelligence-assisted comments.

10. The separation of duties system of claim 1, wherein the text assistant chatbot is configured to extract contextual information from dropdown selections and other structured form elements to inform guidance generation.

11. A computer-implemented method comprising the steps of:
initiating, via an interactive user interface, a separation of duties (SOD) exception interface executing on a SOD conflict detection and resolution system;
activating, via the interactive user interface, a text assistant chatbot corresponding to the SOD exception interface;
receiving, via the text assistant chatbot, one or more queries associated with a user input type relating to the SOD exception interface;
transmitting, via the text assistant chatbot, the one or more queries to a data retrieval interface that is communicatively coupled to a retrieval augmented generation large language model and a vector database that provides real-time contextual information and further communicatively coupled to an artificial intelligence model that generates an AI-based response using the real-time contextual information;
identifying, via the interactive user interface, the user input type on the SOD exception interface as a selection-based input or a free-text input;
responsive to the user input type, identifying one or more prior selections and the real-time contextual information;
providing, via the text assistant chatbot, text guidance based on the one or more prior selections, the real-time contextual information and the AI-based response; and
synchronizing one or more interactions via the text assistant chatbot with one or more inputs on the interactive user interface.

12. The method of claim 11, wherein the text assistant chatbot is configured to analyze free-text input with respect to one or more sufficiency and relevance metrics.

13. The method of claim 11, wherein the text assistant chatbot is configured to provide iterative feedback when the free-text input fails to meet one or more quality thresholds.

14. The method of claim 11, wherein the vector database stores embeddings that represent semantic content of the one or more queries in a numerical vector format suitable for similarity comparison operations.

15. The method of claim 11, wherein the retrieval augmented generation large language model is configured to perform one or more similarity searches.

16. The method of claim 15, wherein the one or more similarity searches use cosine similarity metrics to identify relevant document chunks.

17. The method of claim 11, wherein the text assistant chatbot is configured to maintain conversation context across multiple user interactions within a single form session.

18. The method of claim 11, further comprising a threshold mechanism configured to present alternative options after a predetermined number of insufficient comment attempts.

19. The method of claim 18, wherein the alternative options comprise: submitting current comments with warnings, modifying comments with additional guidance, and generating artificial intelligence-assisted comments.

20. The method of claim 11, wherein the text assistant chatbot is configured to extract contextual information from dropdown selections and other structured form elements to inform guidance generation.
